(19) United States
(12) Patent Application Publication
(10) Pub. No.: US 2023/0009701 A1
(43) Pub. Date: Jan. 12, 2023

(54) ACTIVE SPRAY ADJUSTMENT FOR AN AUTOMATED MOBILE SPRAYER

(71) Applicant: Graco Minnesota Inc., Minneapolis, MN (US)

(72) Inventors: Charles W. Dawson, Otsego, MN (US); John P. Saunders, Brooklyn Park, MN (US); Dale C. Pemberton, Big Lake, MN (US)

(21) Appl. No.: 17/782,412

(22) PCT Filed: Dec. 4, 2020
(86) PCT No.: PCT/US20/63257

§ 371 Date: Jun. 3, 2022

Related U.S. Application Data
(60) Provisional application No. 62/962,005, filed on Jan. 16, 2020.
(60) Provisional application No. 62/944,703, filed on Dec. 6, 2019.

(51) Int. Cl. B05B 13/00; B05B 13/04; B05B 12/16; B05B 12/12

(52) U.S. Cl. CPC B05B 13/005; B05B 13/041; B05B 12/16; B05B 12/124

(57) ABSTRACT

An automated mobile sprayer (AMS) (10) applies fluid sprays to a target surface. The AMS can operate according to a wall-follow routine, where the AMS maintains a spacing and orientation relative to the target surface and shifts a set distance between each spray pass. The AMS is also operable in an overlap adjustment mode where a control module (24) of the AMS actively determines the distance that AMS shifts between each spray pass such that AMS applies the final orthogonal spray on the target surface at an end point of the target surface.

### CROSS-REFERENCE TO RELATED APPLICATION(S)

This application claims the benefit of U.S. Provisional Application No. 62/944,703 filed Dec. 6, 2019 and entitled “ACTIVE SPRAY OVERLAP ADJUSTMENT FOR AN AUTOMATED MOBILE PAINTER,” and claims the benefit of U.S. Provisional Application No. 62/962,005 filed Jan. 16, 2020 and entitled “NON-SPRAY AREA IDENTIFICATION AND NAVIGATION FOR AN AUTOMATED MOBILE SPRAYER,” the disclosures of which are hereby incorporated by reference in their entirety.

### BACKGROUND

This disclosure relates generally to mobile fluid spraying systems. More specifically, this disclosure relates to automated mobile painting systems.

Fluid spray systems produce an atomized fluid spray fan and apply the spray fan to a surface. The spray fan is typically in a horizontal orientation or a vertical orientation. In the horizontal orientation the fan is swept across the surface in vertical passes. In the vertical orientation the fan is swept across the surface in horizontal passes. As such, the spray fan is oriented orthogonal to the sweep direction. Typically, a user operates a spray gun to apply the fluid to the surface.

Automated painting systems are typically used to paint components, such as doors and panels. The autonomous painting systems utilize a robotic arm that moves through three-dimensional space to apply paint to the component. The robotic arms are complex and require multiple joints to provide the degree of freedom necessary to coat the components. Moreover, the robotic arm requires the component to move to a position where the arm can reach the component, as a base of the robotic arm is fixed on a factory floor.

### SUMMARY

According to an aspect of the disclosure, an automated mobile sprayer configured to spray fluids onto a target surface includes a mobile base; a spray module supported by the mobile base, the spray module movable along a vertical axis relative to the base and the target surface and configured to generate a fluid spray for application on the target surface; at least one front sensor oriented to look ahead on a travel path of the AMS and to generate look-ahead data regarding a distance to an object in the travel path; and a control module configured to receive the look-ahead data from the at least one front sensor, determine a distance to an end point of the target surface, and control shifting of the AMS relative to the target surface based on the distance to the object. The control module is configured to dynamically adjust an overlap distance that the AMS shifts relative to the target surface such that a final orthogonal stripe applied to the target surface is at the end point of the target surface.

According to an additional or alternative aspect of the disclosure, a method of spraying fluid onto a target surface with an automated mobile sprayer includes applying spray fluid the target surface with the AMS according to a wall-follow routine, wherein a control module of the AMS causes the AMS to shift laterally relative to the target surface by an initial overlap distance between each stripe applied to the target surface; determining, by the control module, an operating distance to an end point of the target surface; comparing, by the control module, the operating distance to a threshold; and initiating, by the control module, a dynamic overlap routine based on the comparison indicating that the operating distance is one of equal to and less than the threshold. During the dynamic overlap routine, the control module is configured to dynamically adjust the initial overlap distance to a dynamic overlap distance and to cause the AMS to shift laterally relative to the target surface by the dynamic overlap distance during the dynamic overlap routine such that a final orthogonal spray applied to the target surface is disposed at the end point of the target surface.

According to another additional or alternative aspect of the disclosure, an automated mobile sprayer (AMS) configured to spray fluids onto a target surface includes a mobile base having a lateral axis and a longitudinal axis; a drive system that moves the mobile base; a spray module supported by the mobile base, the spray module movable along a vertical axis relative to the base, the spray module including a nozzle configured to spray the fluid longitudinally towards the target surface; one or more indicator sensors configured to sense a first indicator encountered by the AMS and generate first indicator data based on the sensed first indicator; and control circuitry. The control circuitry is configured to drive the AMS via the drive system along the target surface, detect a non-spray area in the target surface based on the first indicator data, and control spraying by the AMS based relative to the non-spray area based on the first indicator data.

According to yet another additional or alternative aspect of the disclosure, a spray system includes at least one indicator disposed relative a non-spray area of a target surface and an automated mobile sprayer (AMS) configured to spray fluids onto the target surface. The AMS includes a mobile base having a lateral axis and a longitudinal axis; a drive system that moves the mobile base; a spray module supported by the mobile base, the spray module movable along a vertical axis relative to the base, the spray module including a nozzle configured to spray the fluid longitudinally towards the target surface; an indicator sensor configured to sense the at least one indicator and generate indicator data regarding the at least one indicator; and control circuitry. The control circuitry is configured to drive the AMS via the drive system along the target surface, detect the non-spray area in the target surface based on the indicator data, and control spraying by the AMS, based on the indicator data, such that the AMS does not apply fluid spray to the non-spray area.

According to yet another additional or alternative aspect of the disclosure, a method includes shifting an automated mobile sprayer (AMS) laterally relative to a target surface in a first lateral direction; spraying fluid onto the target surface from a spray module of the AMS as the spray module moves relative to the target surface; sensing, by an indicator sensor of the AMS, an indictor disposed proximate a non-spray area of the target surface; and stopping, by a control module of the AMS, spraying based on the indicator sensor sensing the indicator.

### BRIEF DESCRIPTION OF THE DRAWINGS

FIG. 1A is an isometric view of an automated mobile spray system.

FIG. 1B is a side elevation view of an automated mobile sprayer.

FIG. 1C is a top schematic plan view of an automated mobile sprayer.

FIG. 1D is a schematic of vertical fluid stripes.

FIG. 2A is a top schematic plan view of an automated mobile sprayer.

FIG. 2B is a schematic of a spray area showing non-spray areas and indicators.

FIG. 3 is an isometric view of another automated mobile sprayer.

FIG. 4 is a flow chart illustrating a method of automated mobile spraying.

FIG. 5 is a flow chart illustrating a method of overlap adjustment.

FIG. 6 is a flow chart illustrating a method of automated mobile spraying.

### DETAILED DESCRIPTION

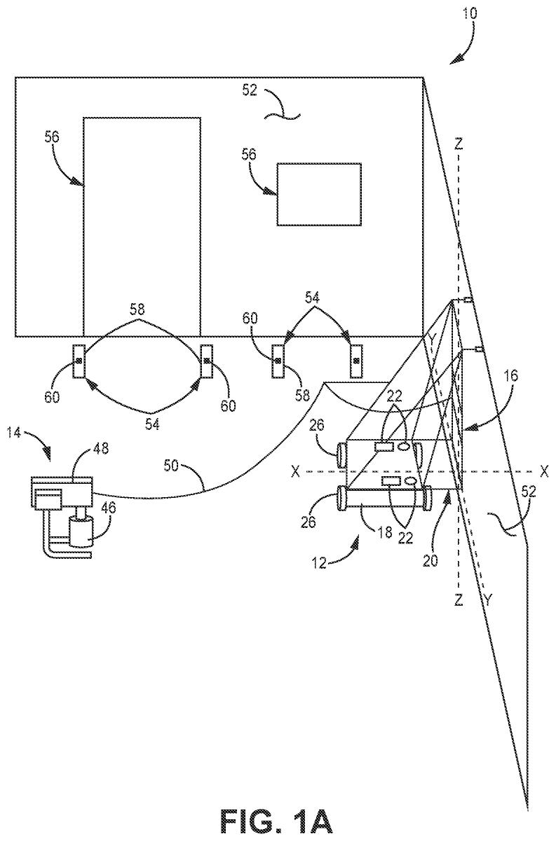

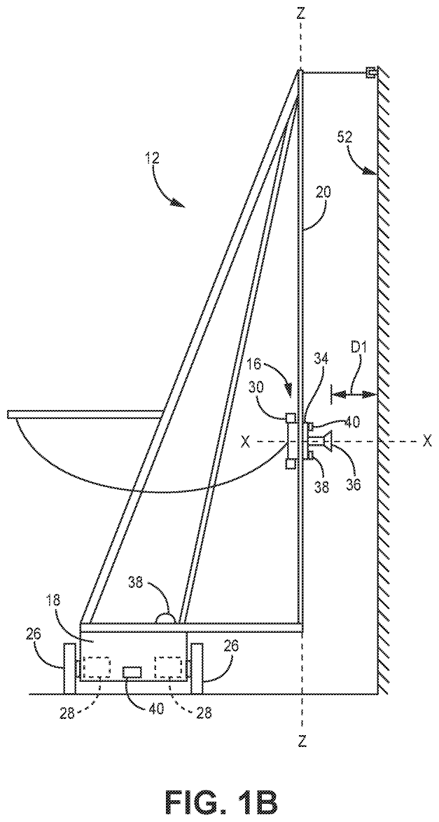

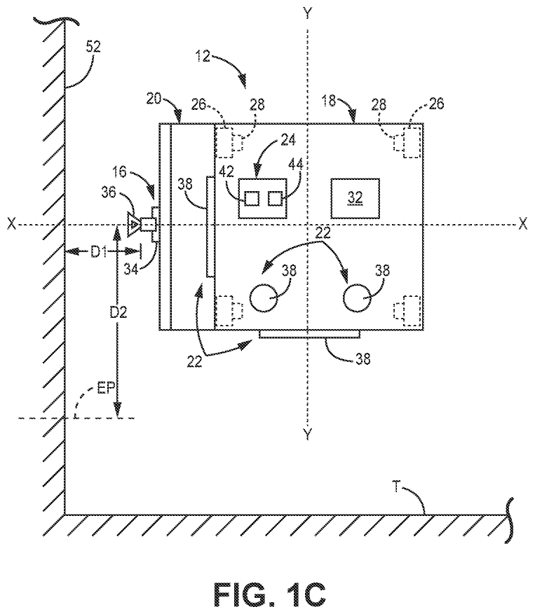

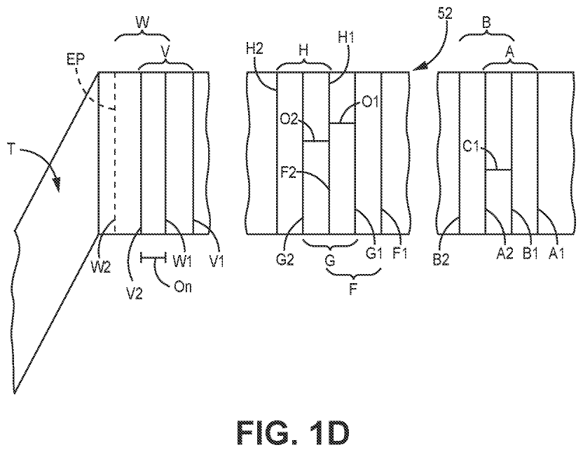

FIG. 1A is an isometric view of automated mobile spraying system 10. FIG. 1B is a schematic side elevation view of automated mobile sprayer (AMS) 12. FIG. 1C is a top schematic plan view of AMS 12. FIG. 1D is a schematic diagram of vertical fluid stripes. FIGS. 1A-1D will be discussed together. Automated mobile spraying system 10 includes AMS 12 and fluid supply 14, and indicators 54. AMS 12 includes spray module 16, base 18, support 20, sensors 22, control module 24, wheels 26, wheel drives 28, applicator drive 30, and user interface 32. Spray module 16 includes spray body 34 and nozzle 36. Sensors 22 include distance sensors 38 and indicator sensors 40. Distance sensors 38 include wall sensors 38a and path sensors 38b. Control module 24 includes memory 42 and control circuitry 44. Fluid supply 14 includes reservoir 46, pump 48, and supply hose 50. AMS 12 includes longitudinal axis X-X, lateral axis Y-Y, and vertical axis Z-Z that are defined relative to AMS 12.

AMS 12 is a mobile vehicle configured to apply a fluid, such as paint, primer, varnish, water, oil, stains, finishes, coatings, and solvents, among others, onto a target surface, such as surface 54. Example surfaces can be interior, such as interior walls, or exterior, such as buildings, among other options. In the example shown, AMS 12 is a mobile ground vehicle.

Base 18 supports various components of AMS 12. Base 18 can be made of any desired material for housing and/or supporting the various components of AMS 12. For example, base 18 can be made from metal and/or composite. In some examples, base 18 is weighted to prevent tipping of AMS 12 during operation. Wheels 26 are disposed on base 18 and provide motive power to base 18. Wheels 26 are oriented to drive AMS 12 parallel to the surface 52 being sprayed. Wheel drives 28 are disposed in base 18 and are operatively connected to wheels 26. As shown, each wheel 26 is associated with an individual wheel motor 32. Each wheel motor 32 individually controls each wheel 26 to drive lateral movement of AMS 12 and to cause turning of AMS 12. In some examples, AMS 12 steers via a skid steer technique, while in other examples AMS 12 steers by wheels 26 reorienting to face various drive directions. Wheel drives 28 can be any suitable motor for driving wheels 26, such as DC electric motors, stepper motors, pneumatic motors, gas-powered motors, brushed electric motors, brushless electric motors, or any other desired motor. Where wheel drives 28 are pneumatic, base 18 can support an air compressor to provide compressed air to drive wheel drives 28. While AMS 12 is described as including wheels 26, it is understood that AMS 12 can include any desired form of locomotion. For example, AMS 12 can include tracks or a combination of wheels and tracks, among other options.

Support 20 extends from base 18. Spray module 16 rides on and is support by support 20. Spray module 16 is supported by base 18 by way of support 20. Support 20 supports spray module 16 such that spray module 16 can move vertically along axis Z-Z while being prevented from moving relative to support 20 along either axis X-X or axis Y-Y. In one example, support 20 includes grooves that receive projections extending from spray module 16. It is understood that spray module 16 can be supported within support 20 and can translate along support 20 in any desired manner.

Applicator drive 30 is operatively associated with spray module 16 and is configured to drive spray module 16 along axis Z-Z relative to support 20 and surface 52 to apply fluid stripes to surface 52. In some examples, applicator drive 30 shifts along axis Z-Z along with spray module 16. For example, applicator drive 30 can include one or more motors, such as electric motors, configured to drive gears interfacing with grooves formed by or within support 20. It is understood, however, that applicator drive 30 can be of any configuration suitable for driving spray module 16 along axis Z-Z.

Nozzle 36 extends from spray body 34 towards surface 52. Spray body 34 houses other components of spray module 16, such as a control valve (not shown). Nozzle 36 is configured to generate a spray of fluid for application to surface 52. It is understood that nozzle 36 can eject the spray in any desired configuration, such as a spray fan or a spray cone, among other options. It is further understood that the desired position of nozzle 36 can include both a coordinate position, such as a distance to surface 52, and an orientation, such as nozzle 36 being orthogonal to surface 52 or at another angle relative to surface 52. In some examples, a non-orthogonal spray fan provides a satisfactory finish. In some examples, the spray orientation is maintained throughout each spray pass. The quality of the finish applied to surface 52 depends on several factors, such as the distance that nozzle 36 is spaced from surface 52, the desired spray fan width, the thickness of the coating being applied, the type of fluid, the spray pressure, and the size of the orifice in nozzle 36, among other factors.

In some examples, nozzle 36 can be positioned in multiple positions to change the orientation of the spray fan. For example, nozzle 36 can orient the spray fan vertically, such that the spray fan is elongate along vertical axis Z-Z. In such an example, spray module 16 can be held stationary on vertical axis Z-Z and AMS 12 can translate along axis Y-Y and relative to surface 52 to apply horizontal fluid stripes. Nozzle 36 can be positioned to orient the spray fan horizontally, such that the spray fan is elongate along lateral axis Y-Y. In such an example, AMS 12 is held stationary on axis Y-Y and spray module 16 translates along axis Z-Z to apply vertical fluid stripes to surface 52. In some examples, nozzle 36 is rotatable between the vertical fan orientation and the horizontal fan orientation.

In examples where AMS 12 includes a control valve, the control valve controls the emission of fluid spray by nozzle 36. The control valve can be an actively controlled valve or a passively controlled valve. For example, control module 24 can cause the valve to shift open to allow spraying when the valve is actively controlled. Fluid pressure can cause the valve to shift open when the valve is passively controlled. The control valve can be communicatively connected to control module 24 to receive commands from control module 24. The control valve can shift between a closed position, where the fluid cannot flow to nozzle 36, and an open position, where the fluid flows to nozzle 36 to be ejected as the spray. For example, the control valve can include a needle (not shown) extending to a seat in nozzle 36 and an actuator (not shown) for actuating the needle. In some examples, AMS 12 does not include a control valve such that nozzle 36 generates the spray fan whenever pump 48 is providing the pressurized fluid. Pump 48 and/or the control valve can be operatively connected to control module 24 such that control module 24 controls spraying by AMS 12.

Control module 24 is configured to store software, implement functionality, and/or process instructions. Control module 24 is configured to perform any of the functions discussed herein, including receiving an output from any sensor referenced herein, detecting any condition or event referenced herein, and controlling operation of any components referenced herein. Control module 24 can be of any suitable configuration for controlling operation of components of AMS 12, gathering data, processing data, etc. For example, control module 24 can receive sensor data from sensors 22, generate drive commands, send the drive commands to wheel drives 28 to cause movement of AMS 12, generate spray commands to cause spray module 16 to emit fluid spray, control movement of spray module 16 along vertical axis Z-Z, and implement routines based on received data, among other options.

Control module 24 can be formed by various controllers located within base 18 or at other locations on AMS 12. It is understood that control module 24 can include hardware, firmware, and/or stored software, and control module 24 can be entirely or partially mounted on one or more boards. Control module 24 can be of any type suitable for operating in accordance with the techniques described herein. While control module 24 is illustrated as a single unit, it is understood that control module 24 can be disposed across one or more boards. In some examples, control module 24 can be implemented as a plurality of discrete circuitry subassemblies.

Control module 24 can communicate via wired and/or wireless communications, such as serial communications (e.g., RS-232, RS-485, or other serial communications), digital communications (e.g., Ethernet), WiFi communications, cellular communications, or other wired and/or wireless communications. Memory 42 configured to store software that, when executed by control circuitry 44, causes AMS 12 and fluid supply 14 to execute instructions and apply the fluid to a surface. For example, control circuitry 44 can include one or more of a microprocessor, a controller, a digital signal processor (DSP), an application specific integrated circuit (ASIC), a field-programmable gate array (FPGA), or other equivalent discrete or integrated logic circuitry.

Control module 24 can be configured to store information during operation. Memory 42, in some examples, is described as computer-readable storage media. In some examples, a computer-readable storage medium can include a non-transitory medium. The term “non-transitory” can indicate that the storage medium is not embodied in a carrier wave or a propagated signal. In some examples, memory 42 is a temporary memory, meaning that a primary purpose of memory 42 is not long-term storage. Memory 42, in some examples, is described as volatile memory, meaning that memory 42 does not maintain stored contents when power to control module 24 is turned off. Memory 42, in some examples, also includes one or more computer-readable storage media. Memory 42 can be configured to store larger amounts of information than volatile memory. Memory 42 can further be configured for long-term storage of information. In some examples, memory 42 includes non-volatile storage elements.

User interface 32 can be any graphical and/or mechanical interface that enables user interaction with control module 24. For example, user interface 32 can implement a graphical user interface displayed at a display device of user interface 32 for presenting information to and/or receiving input from a user. User interface 32 can include graphical navigation and control elements, such as graphical buttons or other graphical control elements presented at the display device. User interface 32, in some examples, includes physical navigation and control elements, such as physically-actuated buttons or other physical navigation and control elements. In general, user interface 32 can include any input and/or output devices and control elements that can enable user interaction with control module 24. In some examples, user interface 32 can be integrated into AMS 12. For example, user interface 32 can be formed on housing 24 for easy user access. In some examples, user interface 32 can be remote from AMS 12 and communicatively connected to control module 24. User interface 32 can communicate with control module 24 via wired or wireless communications. For example, user interface 32 can be a remote computing device that communicates with control module 24, such as a smartphone or tablet, among other options.

Sensors 22 are configured to sense walls and other structures and features relative to AMS 12. It is understood that sensors 22 can include one or more of distance sensors, location sensors, inertial sensors, proximity sensors, and/or optical sensors. For example, sensors 22 can include one or more of a proximity sensor, radar transducer, vibration echo rangefinder (including ultrasonic and/or acoustic rangefinders), laser rangefinder, magnetometer, radar, lidar, GPS receiver chip, accelerometer, gyroscope, compass, and/or camera. Sensors 22 generate sensor data for AMS 12 and provide that sensor data to control module 24. Control module 24 receives sensor data from sensors 22 and is configured to control movement of AMS 12 and spraying by nozzle 36 based, at least partially, on the sensor data. Sensors 22 can be of any suitable configuration for generating information regarding features in the travel path of AMS 12. For example, various ones of sensors 22 can be oriented towards surface 52, can be oriented along axis Y-Y on the travel path of AMS 12, can be oriented intermediate those two orientations, or can be disposed at any other orientation for generating the data.

Distance sensors 38 are configured to generate distance data regarding objects and features relative to AMS 12. In some examples, distance sensors 38 can be oriented towards surface 52. In some examples, distance sensors 38 can be oriented to look ahead on a travel path of the AMS 12. It is understood that AMS 12 can include multiple distance sensors disposed at various orientations to generate distance data.

Wall sensors 38a are distance sensors oriented towards surface 52. Wall sensors 38a can provide relevant locational information to control module 24 regarding the position and orientation of nozzle 36 relative to surface 52. In some examples, AMS 12 includes two wall sensors 38a spaced from nozzle 36. It is understood, however, that AMS 12 can include more than two wall sensors 38a. In some examples, the multiple wall sensors 38a are spaced equidistantly relative to nozzle 36 on opposite sides of nozzle 36. It is understood, however, that the locations of wall sensors 38a are known to control module 24 such that wall sensors 38a can be disposed at any desired location on AMS 12 suitable for generating distance data regarding a spacing to surface 52. In some examples, wall sensors 38a are non-equidistant relative to nozzle 44.

Path sensors 38b are distance sensors oriented to look ahead of AMS 12 to detect features in the travel path of AMS 12. For example, path sensors 38b can detect variations in surface 52, such as a bump out or intersection with another surface. In some examples, AMS 12 includes multiple path sensors 38b disposed at various orientations. For example, AMS 12 can include one or more path sensors 38b oriented to look along axis Y-Y in the travel path of AMS 12, such path sensors 38b can also be referred to as front sensors. AMS 12 can further include one or more path sensors 38b oriented to look along orientations between axis X-X and axis Y-Y, such path sensors 38b can be referred to as intermediate sensors. Path sensors 38b are configured to generate distance data regarding the spacing to a feature that AMS 12 is approaching, such as the distance to a void formed in surface 52 or an end of surface 52, such as where walls intersect.

Indicator sensors 40 are sensors configured to detect the presence of indicators 54 and generate indicator data regarding the presence of an indicators 54. In some examples, AMS 12 includes multiple indicator sensors 40 configured to sense various indicators 54. Indicator sensors 40 are configured to detect the presence of indicators 54 and generate signals regarding the presence of an indicator 54. Indicator sensors 40 can be disposed at any desired position on AMS 12 suitable for sensing indicators 54. For example, indicator sensors 40 can be disposed on or in base 18, can be mounted to spray module 16, or can be disposed at any other suitable location. In examples where indicator sensors 40 are mounted to spray module 16, the indicator sensors 40 can travel vertically with spray module 16.

Indicator sensors 40 can include any one or more of optical sensors and proximity sensors, among other options. In examples where indicator sensors 40 are optical sensors, the optical sensors can be oriented to look ahead on the travel path of AMS 12 and/or spray module 16. For example, an optical sensor can be mounted to spray module 16 to travel with spray module 16 and can be oriented to look ahead on the travel path of spray module 16 such that the optical sensor detects indicator 54 prior to nozzle 36 reaching indicator 54.

Indicator sensors 40 can utilize proximity sensing techniques, such as passive and/or active radio frequency identification (RFID) sensing, near field communication (NFC), inductive sensing, capacitive sensing, or other proximity sensing techniques. For instance, an RFID tag can be associated with, such as located on or within, one of indicator 54 and AMS 12 and an RFID reader can be associated with the other of indicator 54 and AMS 12. An NFC tag can be associated with, such as located on or within, one of indicator 54 and AMS 12 and an NFC reader can be associated with the other of indicator 54 and AMS 12. A first inductive or capacitive sensing component can be associated with, such as located on or within, one of indicator 54 and AMS 12 and a second inductive or capacitive sensing component can be associated with the other of indicator 54 and AMS 12.

Indicators 54 are located relative to non-spray areas 56. The user can place indicators 54 relative non-spray areas 56 when preparing the site for spraying. Non-spray areas 56 are those areas of the target surface 52 on which fluid is not meant to be applied. For example, non-spray areas 56 can include voids, such as doorways and windows, among other options. Indicators 54 are located proximate the non-spray area 56 to indicate the boundaries of the non-spray area 56. In some examples, indicators 54 include circuitry configured to store information regarding the non-spray area 56 and/or instructions regarding spraying relative the non-spray area 56. For example, the indicator 54 can provide instructions that the AMS 12 should stop at the indicator 54 and await further instructions from the user, that the AMS 12 should traverse laterally relative to the target surface 52 without spraying until encountering another indicator 54, that the AMS 12 should apply fluid to certain portions of the target surface 52 and not others (such as above and below a window, where the information includes the dimensions and location of the window), etc.

Indicator 54 can be a mat, puck, or other object placed on the ground surface. In the example shown, indicator 54 is placed on the ground surface adjacent the non-spray area 56. The mat can include a marker, such as a proximity sensor component embedded within the mat. In such an example, the mat is a support 58 component that the sensor component 60, which can include circuitry, is supported by. For example, an RFID component, such as an RFID tag or RFID reader, an NFC component, such as an NFC rag or NFC reader, or an induction sensing component can be embedded in the mat as the sensor component 60. In some examples, indicator 54 can be formed from a material configured to be sensed by indicator sensor 40. For example, indicator 54 can be formed from or include metallic components configured to be sensed by a magnetic sensor forming indicator sensor 40, such as where the indicator 54 is a metallic plate or includes metallic elements. Indicator sensor 40 is configured to sense the marker and generate indicator data based on that detection. In some examples, AMS 12 is configured to drive over indicator 54 to sense indicator 54.

Fluid supply 14 stores fluid and provides fluid to AMS 12 for application to surface 52. While fluid supply 14 is shown disposed off-board of AMS 12, it is understood that, in some examples, fluid supply 14 can be on-board AMS 12. For example, reservoir 46 and pump 48 can be disposed in housing 24 of AMS 12.

Reservoir 46 is configured to store a bulk volume of fluid. Pump 48 is disposed on reservoir 46 and is configured to draw fluid out of reservoir 46, pressurize the fluid, and drive the fluid downstream to nozzle 36 of AMS 12. Reservoir 46 is any suitable vessel for storing a supply of fluid prior to application. For example, reservoir 46 can be a bucket. Pump 48 can be a piston pump, a diaphragm pump, a peristaltic pump, or any other suitable pump for driving the fluid to nozzle 36 of AMS 12 under pressure. In some examples, pump 48 generates sufficient pressure to cause nozzle 36 to atomize the fluid and generate the spray fan. In other examples, AMS 12 can include a secondary pump configured to generate the high pressure (about 3.45-27.58 MPa (about 500-4,000 psi)) required to atomize the fluid. As such, pump 48 can, in some examples, be a low pressure pump for driving the fluid to the onboard pump, which then generates the desired spray pressure. Supply hose 50 extends from pump 48 to AMS 12 to provide the pressurized fluid to nozzle 36 of AMS 12 for application to surface 52. In some examples, supply hose 50 extends from pump 48 to spray body 34.

During operation, AMS 12 generates and applies sprays of fluid, such as paint, on surfaces that can be difficult for humans to easily access and/or efficiently apply the fluid. In some examples, AMS 12 applies fluid to a surface using a plurality of parallel, raster passes. A raster pass occurs when a first horizontal or vertical stripe is applied to a surface, and the second horizontal or vertical stripe is applied directly adjacent and/or overlapping with the first stipe. Any number of stripes can be applied until the surface 52 is sufficiently coated. In some embodiments, the entirety of the pump 48 and/or the reservoir 46 are carried onboard the AMS 12. For example, one or both of the pump 48 and the reservoir 46 can be supported on base 18 as the AMS 12 propels itself.

Pump 48 is activated, either autonomously by control module 24, or by the user, and pump 48 draws the fluid from reservoir 46 and drives the fluid downstream to nozzle 36 through supply hose 50. Nozzle 36 generates the spray and traverses surface 52, laterally and/or vertically, to apply the fluid to surface 52. Control module 24 causes the relative vertical movement of nozzle 36 by shifting spray module 16 along axis Z-Z to move nozzle 36 vertically. Control module 24 causes the relative horizontal movement of nozzle 36 by driving wheels 26 to shift AMS 12 and thus nozzle 36 laterally along axis Y-Y. The control module 24 controls the positioning of AMS 12 during spraying based on distance data generated by sensors 22. For example, control module 24 can control the spacing between AMS 12 and surface 52 based on distance data generated by wall sensors 38a.

AMS 12 initially operates according to a wall-follow routine. During the wall-follow routine, AMS 12 is driven along axis Y-Y and distance D1 between nozzle 36 and surface 52 is maintained. Control module 24 can cause AMS 12 to operate in a wall-follow mode and/or an overlap adjustment mode during the wall-follow routine. During the wall-follow routine, control module 24 controls movement of AMS 12 along axis Y-Y to such that AMS 12 is disposed at a desired orientation relative to surface 52 for spraying. For example, control module 24 can control AMS 12 such that axis Y-Y is substantially parallel to surface 52 during spraying. Where the multiple wall sensors 38a each indicate the same distance to surface 52, then control module 24 determines that nozzle 36 is oriented orthogonal to surface 52 and further knows the distance D1 that nozzle 36 is spaced from surface 52. If one of wall sensors 38a indicates a different distance than the other of wall sensors 38a, then control module 24 can determine that nozzle 36 is obliquely tilted away from surface 52 and towards whichever wall sensor 38a indicates a further distance to surface 52 than the other wall sensor 38a.

Control module 24 can implement corrective action to reorient AMS 12 to the desired spraying position based on the information provided by wall sensors 38a. For example, control module 24 can command one or more of wheel drives 28 to cause rotation of wheels 26 to reorient AMS 12 to the desired spray position. For example, where one wall sensor 38a indicates a greater distance to surface 52 than another wall sensor 38a, control module 24 can adjust the orientation of AMS 12 until both wall sensors 38a indicate the same distance, and such that that indicated distance is the desired distance.

During spraying of both horizontal and vertical stripes, control module 24 can control spraying based on raster stripes. FIG. 1D shows an example where AMS 12 applies vertical fluid stripe A, bounded by vertical lines A1 and A2, and vertical fluid stripe B, bounded by vertical lines B1 and B2. Lines A1 and A2 represent the lateral boundaries of a first spray fan applying a stripe A to surface 52, and lines B1 and B2 represent the lateral boundaries of a second spray fan applying a stripe B to surface 52. As shown, the first spray fan and the second spray fan are adjacent and overlapping. Vertical stripe A and vertical stripe B overlap by overlap parameter C1. When operating in the wall-follow mode, the overlap parameter can be preset in control module 24 and/or provided by the user to control the amount of overlap between adjacent stripes. The overlap parameter C1 can be a programmable distance or a percentage of overlap between stripes. For example, a 50% overlap parameter indicates that half of each stripe is applied over the previous stripe such that each portion of surface 52 is coated twice.

An example spray event where AMS 12 applies vertical stripes is discussed further herein. Nozzle 36 generates a horizontal spray fan when applying vertical stripes of fluid. The horizontal spray fan is laterally elongate relative to surface 52 and along axis Y-Y. A spray routine can be initiated by control module 24 and/or by the user. When the spray routine is initiated, control module 24 positions AMS 12, and thus spray module 16 and nozzle 36, at the desired start location. Control module 24 controls movement of AMS 12 via wheel drives 28. AMS 12 moves to position nozzle 36 at the desired distance, location, and orientation relative to surface 52.

Pump 48 is activated, by control module 24 or the user, to drive fluid downstream to nozzle 36. In some examples, control module 24 can provides a start spray command to the control valve to initiate spraying. The start spray command causes the control valve to open a flow path through nozzle 36, such as by actuating a needle to open the flow path. The fluid flows through the flow path and is ejected as an atomized spray by nozzle 36. In some examples, the control valve is passively actuated to an open state when sufficient pressure is generated by pump 48. To stop spraying, control module 24 can deactivate pump and/or cause the control valve to shift to the closed position, among other options.

Control module 24 controls spraying to apply a smooth and even finish on surface. In some examples, control module 24 controls spraying such that nozzle 36 is in motion relative to surface 52 before fluid is sprayed from nozzle 36. Beginning spraying when nozzle 36 is in motion decreases or, in some examples, eliminates the unwanted effect caused by spitting, which most commonly occurs as spraying starts and as spraying ends. With nozzle 36 already in motion, any unwanted spray pattern is evenly distributed on surface 52 and can be corrected with subsequent fluid application. Control module 24 can implement a delay between activating wheel drives 28 or applicator drive 30 and opening of control valve 46 to delay spraying until nozzle 36 is in motion.

Control module 24 generates a spray command and provides the spray command to applicator drive 30 to initiate vertical movement of spray module 16 along vertical axis Z-Z. Nozzle 36 emits the fluid spray and spray module 16 applies a first vertical stripe of fluid to surface 52. Control module 24 can cause AMS 12 to initially operate in the wall-follow mode.

After a first vertical stripe is applied, control module 24 activates wheel drives 28 to cause AMS 12 to shift laterally along axis Y-Y and relative to surface 52 according to the initial overlap parameter C1 to apply second and additional vertical stripes. The initial overlap parameter C1 can be set by the user or determined by control module 24, such as at the beginning of a spray event. For example, if each stripe is 12 inches (in.) (about 30.48 centimeters (cm)) wide, then an overlap parameter of 50% provides an overlap distance of 6 in. (15.24 cm). In some examples, the overlap parameter is the overlap distance, which is 6 in. in the example discussed. Control module 24 causes AMS 12 to shift according to the initial overlap parameter between each stripe application. AMS 12 continues to apply stripes based on the initial overlap parameter C1 until control module 24 enters the overlap adjustment mode.

Path sensors 38b generate data regarding the distance to features in surface 52. The features can be a window, doorway, wall transition, or other feature in surface 52. Control module 24 can cause the AMS 12 to apply fluid to surface 52 until the feature is reached. It is understood that applying fluid until reaching the feature can include stopping short of the feature itself at an end point EP associated with that feature, which end point EP can be located at the feature or spaced from the feature. For example, the end point EP can be located at a point on surface 52 where the wall-follow routine ends and another routine, such as a wall-transition routine, is implemented. In such an example, the end point EP can be spaced a sufficient distance from an adjacent wall such that AMS 12 has room to maneuver relative to the transition and orient on the adjacent wall to spray on the adjacent wall. Control module 24 can determine the end point EP by applying a spacing factor, which can be the distance from wall that AMS 12 is spaced at the beginning of another routine, to the distance D2. For example, control module 24 can determine the distance to end point EP by subtracting the spacing factor from distance D2.

During the wall-follow routine, drive errors and sensor errors can cause the actual overlap between adjacent stripes to vary from the initial overlap parameter C1. For example, the wheels 26 may shift AMS 12 slightly less or more than the commanded drive distance, or the orientation of AMS 12 relative to surface 52 can require adjustment to provide parallelism prior to spraying a stripe. The accuracy of path sensors 38b also increases as the distance D2 to surface T decreases. Such errors and/or the physical make-up of surface 52 can cause the pass count, which is a count of stripe applications required to reach the end point EP of surface 52, to become a fractional pass count as AMS 12 approaches surface T.

Control module 24 is configured to adjust the initial overlap parameter during operation. The adjustment can account for the inaccurate repositioning movements due to drive and/or sensor errors. In some examples, control module 24 dynamically adjusts the overlap parameter during operation. Control module 24 adjusts the overlap parameter C1 based on the travel distance D2 remaining to the feature of surface 52. Control module 24 can determine the travel distance D2 based on the distance data provided by path sensors 38b. Control module 24 adjusts the initial overlap parameter such that the last orthogonal fluid stripe W applied on surface 52 by AMS 12 is a full stripe. The dynamic overlap adjustment ensures that the final stripe does not leave an unsprayed gap between the final stripe and the feature of surface 52 while maintaining sufficient overlap between adjacent stripes to provide the desired coverage. AMS 12 continues to follow along surface 52 while applying fluid when operating in the overlap adjustment mode. As such, the wall-follow routine can include both the wall-follow mode and the overlap adjustment mode.

Control module 24 can control operation of AMS 12 based on a dynamic overlap routine when operating in the overlap adjustment mode. The overlap adjustment routine causes AMS 12 to apply a full final orthogonal stripe at the end point EP of surface 52. Control module 24 can dynamically adjust the overlap parameter as AMS 12 approaches the feature after each fluid stripe application and as AMS 12 approaches the feature. Control module 24 can initiate the overlap adjustment mode based on an operating parameter and an adjustment threshold. For example, control module 24 can be configured to operate AMS 12 in the overlap adjustment mode when the operating parameter reaches the adjustment threshold. The adjustment threshold can be a distance to the end point EP or a remaining pass count, which is a count of the number of stripes remaining to reach the end point EP, among other options. Upon reaching the adjustment threshold, control module 24 can enter the overlap adjustment mode and control AMS 12 according to the overlap adjustment routine. During the overlap adjustment routine, control module 24 determines a dynamic overlap parameter and controls movement of AMS 12 along axis Y-Y and relative to surface 52 based on the dynamic overlap parameter. The dynamic overlap parameter can vary throughout the overlap adjustment routine such that the overlap adjustment routine includes a plurality of dynamic overlap parameters O1-On. As such, the dynamic overlap parameter can be dynamic and can vary during operation.

During the overlap adjustment routine, control module 24 determines the dynamic overlap parameter prior to shifting AMS 12 to apply the next stripe. Control module 24 receives look-ahead data from path sensors 38b and determines the distance to the end point EP of surface 52 based on the look-ahead data. For example, front sensors of path sensors 38b can generate distance data regarding the spacing to an interior corner or other projection while intermediate sensors of path sensors 38b can generate distance data regarding the spacing to an outside corner or other void.

Control module 24 can determine the number of stripes that need to be applied to reach the feature of surface 52. Control module 24 can implement the overlap adjustment routine such that the final orthogonal spray relative to surface 52 is applied at a desired location relative to the feature of surface 52 to prevent any gaps or uneven spraying. The overlap adjustment routine further causes AMS 12 to evenly apply fluid as AMS 12 approaches the end of the wall-follow routine.

In some examples, control module 24 can initiate the overlap adjustment routine based on a threshold distance. In such an example, control module 24 can cause AMS 12 to continue to operate according the wall-follow routine if the distance D2 to the end point EP/feature is greater than the threshold distance. Control module 24 initiates the overlap adjustment routine based on distance D2 equaling or being less than the threshold distance. The threshold distance can be any desired distance from the end point EP of surface 52, such as 12 in. (30.48 cm), 24 in. (60.96 cm), 36 inches (91.44 cm), 48 in. (121.92 cm), 60 in. (152.40 cm), or more from the end point EP, or any intermediate distance value.

In other examples, control module 24 can be configured to initiate the overlap adjustment routine based on a threshold pass count. In such an example, control module 24 can cause AMS 12 to continue to operate according to the wall-follow routine if the remaining pass count exceeds the threshold pass count. Control module 24 initiates the overlap adjustment routine based on the remaining pass count equaling or being less than the threshold pass count. The threshold pass count can be any desired number of passes remaining to the end point EP of surface 52, such as three, four, five, ten, fifteen, or more passes remaining or any intermediate number of passes remaining.

An example of an overlap adjustment routine based on a threshold distance is discussed in more detail. In the example discussed, the spray fan has a width of 12 inches, an initial overlap parameter C is 50%, a threshold distance is 36 inches, and a distance D2 is 34 in. (86.36 cm). Control module 24 receives look-ahead data from path sensors 38b and determines that distance D2 is 34 inches based on the look-ahead data. Control module 24 compares the distance D2 to the threshold distance. The distance D2 is less than the threshold distance, so control module 24 initiates the overlap adjustment routine. Control module 24 determines an initial remaining pass count of the number of stripes that are required to fully cover surface 52 to reach the end point EP of surface 52. With a 50% overlap parameter C1, each stripe applies an additional six inches of coverage width. The initial remaining pass count can be calculated by dividing distance D2 by the overlap parameter as applied to the width of each stripe. In this example, the remaining pass count has a pass count value of 5.67 stripes.

Control module 24 determines a status of the remaining pass count, such as whether the remaining pass count is a whole number or a fractional number. If the remaining pass count is a fractional number, control module 24 adjusts the remaining pass count to an adjusted remaining pass count that is an integer. The remaining pass count being an integer instead of a fractional number provides a full width final orthogonal stripe W (FIG. 1D) at the end point EP of surface 52. The fractional pass count can be adjusted up or down to the nearest adjacent integer. For example, the initial remaining pass count of 5.67 can be adjusted to an adjusted pass count of five or six. In some examples, control module 24 is configured to adjust the pass count to the nearest integer larger than the fractional remaining pass count, providing an adjusted remaining pass count of six in the example discussed. Adjusting to the larger next integer ensures that each portion of surface 52 receives at least two applications of the fluid. In some examples, control module 24 is configured to adjust the remaining pass count to the closest adjacent integer, providing an adjusted remaining pass count of six in the example discussed. Adjusting to the closest adjacent integer minimizes any difference between the dynamic overlap parameter and the initial overlap parameter.

Control module 24 determines the dynamic overlap parameter based on the adjusted pass count and the distance D2. The distance D2 remaining to the end point EP of surface 52 is divided by the adjusted pass count of six to determine a first dynamic overlap parameter O1, resulting in a first dynamic overlap distance O1 of 5.67 in. (14.40 cm), providing a first dynamic overlap percentage of 47.25%.

As shown in FIG. 1D, the final stripe applied prior to initiating the overlap adjustment routine is vertical fluid stripe F, bounded by vertical lines F1 and F2. Control module 24 causes AMS 12 to shift laterally relative to surface 52 along axis Y-Y by the first dynamic overlap distance O1. AMS 12 applies vertical stripe G, bounded by vertical lines G1 and G2, at that position.

Control module 24 can determine a second dynamic overlap parameter O2 prior to shifting AMS 12 to apply the next vertical stripe H. For example, if AMS 12 actually shifted 5.5 in. to apply the vertical stripe G, then there are 28.5 in. remaining to the end point EP of surface 52. The additional dynamic overlap parameters O2-On can be based on the first adjusted remaining pass count determined during the overlap adjustment routine. The second and subsequent dynamic overlap parameters can thus be determined by dividing the remaining distance, 28.5 inches in this example, by the remaining passes, which is the adjusted remaining pass count minus the number of passes completed during the overlap adjustment routine. In this example, the remaining passes is five. The resulting dynamic overlap parameter O2 has a second dynamic overlap distance of 5.7 in. (14.48 cm), providing a second dynamic overlap percentage of 47.5%.

In some examples, control module 24 is configured to continue applying stripes according to the first dynamic overlap parameter O1 so long as a magnitude of the inaccurate repositioning movement is less than a threshold. For example, if the threshold is 0.2 in. (0.51 cm), then control module 24 can control movement of AMS 12 to apply vertical stripe H based on the first dynamic overlap distance O1 based on the difference between the actual movement and commanded movement (0.17 in. in this example) being less than the threshold. In some examples, the threshold can be cumulative. For example, if additional inaccurate repositioning movement increases the difference to more than the threshold, then control module 24 can determine the second dynamic overlap parameter O2 and control movement based on that second dynamic overlap parameter.

Control module 24 causes AMS 12 to shift laterally relative to surface 52 along axis Y-Y by the second dynamic overlap parameter O2 and to apply vertical stripe H, bounded by vertical lines H1 and H2, at that position. While the same vertical line is shown as both H1 and F2, it is understood that the boundaries of the vertical stripes can vary relative to each other. Control module 24 continues to determine additional overlap parameters O3-On and controls operation of AMS 12 based on those overlap parameters O3-On. AMS 12 continues to apply stripes of fluid according to the overlap adjustment routine. Control module 24 determines the final dynamic overlap parameter On and causes AMS 12 to shift from a position applying the second-to-last stripe V, bounded by vertical lines V1 and V2, to apply the final orthogonal stripe W, bounded by vertical lines W1 and W2. AMS 12 shifts according the dynamic overlap parameter On to apply the final orthogonal stripe W. The vertical line W2 is aligned with the end point EP of surface 52. As such, the final orthogonal stripe W applied to surface 52 is applied at the end point EP of surface 52.

An example of an overlap adjustment routine based on a threshold pass count is briefly discussed in more detail. In the example discussed, the spray fan has a width of 12 inches, an initial overlap parameter is 50%, a threshold pass count is ten passes, and a distance D2 is 58 in. (147.32 cm). Control module 24 determines a remaining pass count of the number of spray passes that are required to fully cover surface 52 prior to reaching the end point EP of surface 52. Control module 24 compares the remaining pass count to the threshold pass count and initiates the overlap adjustment routine based the count of remaining passes being less than or equal to the threshold pass count.

In some examples, control module 24 can subtract a count of completed passes from an initial pass count. In one example, control module 24 determines an initial pass count prior to initiating any spraying on surface 52 based on look-ahead data from distance sensors 38. Control module 24 can subtract the count of completed passes from that initial pass count to determine the remaining pass count. In some examples, the user can input an expected number of passes for surface 52, such as via user interface 32, and that expected number of passes can be the initial pass count. Control module 24 can subtract the count of completed passes from the user-supplied initial pass count.

In some examples, control module 24 determines the remaining pass count based on look-ahead data from distance sensors 38. Control module 24 receives look-ahead data from distance sensors 38 and can determine that distance D2 is 58 inches based on the look-ahead data. The remaining pass count can be calculated by dividing distance D2 by the overlap parameter as applied to the width of each stripe. With a 50% initial overlap parameter, each stripe applies an additional six inches of spray coverage, providing a remaining pass count of 9.67 passes in the example discussed.

Control module 24 adjusts the initial overlap parameter C1 to a dynamic overlap parameter such that the remaining pass count is an integer. The remaining pass count being an integer instead of a fractional number provides a full width final orthogonal spray at the feature of surface 52. The fractional remaining pass count can be adjusted up or down to the nearest adjacent integer. For example, the initial remaining pass count of 9.67 passes can be adjusted to an adjusted remaining pass count of nine or ten. In some examples, control module 24 is configured to adjust the remaining pass count to the nearest integer greater than the fractional remaining pass count, providing an adjusted remaining pass count of ten in the example discussed. Adjusting to the larger next integer causes AMS 12 to coat each portion of surface 52 with at least two applications of the fluid. In some examples, control module 24 is configured to adjust the remaining pass count to the closest adjacent integer, providing an adjusted remaining pass count of ten in the example discussed. Adjusting to the closest adjacent integer minimizes any difference between the dynamic overlap parameter and the initial overlap parameter.

Control module 24 determines the dynamic overlap parameter based on the adjusted pass count and the distance D2. The distance D2 remaining to the end point EP of surface 52 is divided by the adjusted pass count of ten to determine the first dynamic overlap parameter O1, resulting in a first dynamic overlap distance of 5.8 in. (14.73 cm), providing a first dynamic overlap percentage of 48.33%.

As shown in FIG. 1D, the final stripe applied prior to initiating the overlap adjustment routine is vertical fluid stripe F, bounded by vertical lines F1 and F2. Control module 24 causes AMS 12 to shift laterally relative to surface 52 along axis Y-Y by the first dynamic overlap parameter O1. AMS 12 applies vertical stripe G, bounded by vertical lines G1 and G2, at that position.

Control module 24 continues to determine additional dynamic overlap distances O2-On and controls operation of AMS 12 based on those dynamic overlap distances O2-On. Control module 24 determines the final dynamic overlap parameter On and causes AMS 12 to shift from a position applying the second-to-last stripe V, bounded by vertical lines V1 and V2, to apply the final orthogonal stripe W, bounded by vertical lines W1 and W2. AMS 12 shifts according the dynamic overlap parameter On to apply the final orthogonal stripe W. The vertical line W2 is aligned with the end point EP of surface 52. As such, the final orthogonal stripe W of the wall-follow routine is disposed at the end point EP of surface 52.

AMS 12 provides significant advantages. AMS 12 provides automated fluid application. AMS 12 increases productivity by allowing the human operators to focus on other aspects a project while AMS 12 sprays surfaces 68. AMS 12 is able to navigate the room and apply the fluid to the surfaces 68. Control module 24 implements the overlap adjustment routine as AMS 12 approaches the feature of surface 52. The dynamic overlap routine minimizes differences in overlap from an initial overlap parameter while positioning AMS 12 such that the final orthogonal stripe applied to surface 52 is at the end point EP of surface 52. Applying a full final orthogonal stripe prevents gaps from being disposed at the end point EP of surface 52, which gaps would need to be covered by AMS 12 or the user. As such, the overlap adjustment routine increases efficiency and reduces material costs. Applying the full final orthogonal stripe provides a smooth transition from the wall-follow routine to additional routines.

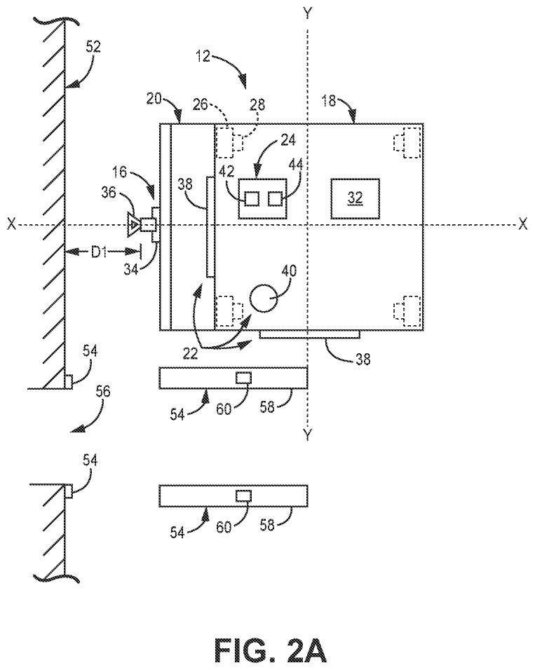

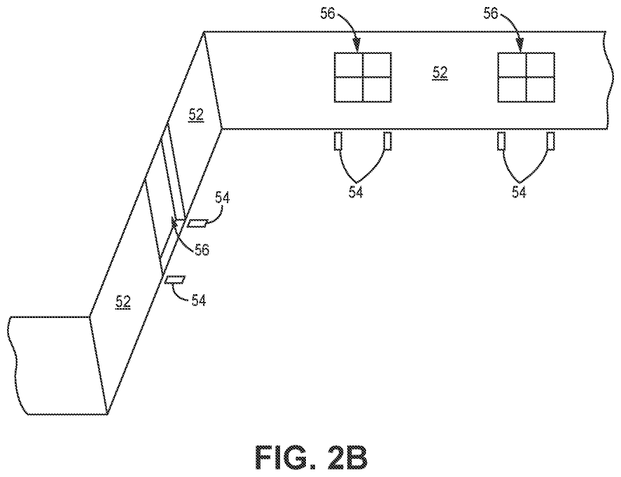

FIG. 2A is a top schematic plan view of AMS 12. FIG. 2B is a schematic of a spray environment showing non-spray areas 56 and indicators 54. FIGS. 2A and 2B will be discussed together.

Control module 24 is configured to control spraying and movement of AMS 12 based on signals received from indicator sensors 40. Indicator sensors 40 can be of any desired configuration suitable for sensing the presence of the indicator 54. In some examples, AMS 12 can include multiple indicator sensors 40 of various configurations thereby facilitating the use of various types of indicators 54 with AMS 12.

Indicators 54 are placed proximate the non-spray areas 56. Indicators 54 can be placed on a ground surface proximate the non-spray area 56. In some examples, indicators 54 can be adhered to or placed on the vertical surface 54. Multiple ones of indicators 54 can bracket non-spray areas 56 to indicate the lateral boundaries of the non-spray areas 56. For example, a first indicator 54 can be placed at the entrance threshold of the void and a second indicator 54 can be placed at the exit threshold of the void. Control module 24 can control movement of AMS 12 and spraying by AMS 12 according to a spray-adjustment routine based on AMS 12 encountering the entrance one of indicators 54. Control module 24 can control movement of AMS 12 and spraying by AMS 12 according to the wall follow routine based on AMS 12 encountering the exit one of indicators 54.

Control module 24 can cause AMS 12 to operate according to a spray-adjustment routine based on indicator sensor 40 sensing indicator 54. During the spray-adjustment routine, the control module 24 controls spraying by and movement of AMS 12 to prevent AMS 12 from applying spray fluid in non-spray area 56. Control module 24 can execute specific instructions regarding the spray-adjustment routine based, at least in part, on the indicator 54 sensed by indicator sensor 40. For example, control module 24 can cause AMS 12 to traverse laterally relative the non-spray area 56 until another indicator 54 is encountered, whereupon control module 24 resumes the wall-follow routine after having passed by the non-spray area 56. In some examples, control module 24 can cause AMS 12 to spray portions of target surface 52 around non-spray area 56, such as above and below a window opening forming the non-spray area 56, and then resume the wall-follow routine after having passed by the non-spray area 56. In some examples, control module 24 can cause AMS 12 to stop at indicator 54 until further instructions are received from the user. The instructions for the various spray-adjustment routines can be stored in memory 42 and recalled based on the indicator 54 encountered.

In some examples, indicators 54 are programmable to provide relevant information regarding the non-spray area 56 to AMS 12. As shown in FIG. 2B, the target surface 52 can include various non-spray areas 56 having various configurations, such as windows and doorways. In some examples, a first subset of indicators 54 can be programmed to associate with a first type of non-spray area 56, such as a window, and a second subset of indicators 54 can be programmed to associate with a second type of non-spray area 56, such as a door. When indicator sensor 40 detects an indicator 54 of the first subset, the information from that indicator 54 can provide detail regarding the first type of non-spray area 56 that that indicator 54 is associated with. For example, the first subset of indicators 54 can be associated with windows that are a certain height above the ground surface and have a certain width. Control module 24 can control spraying by AMS 12 relative to that first type of non-spray area 56 based on the information from the indicator 54, such that the AMS 12 applies fluid around, but not within, the non-spray area 56. When AMS 12 encounter an indicator 54 of the second subset, the information from that indicator 54 can inform the control module 24 about the second type of non-spray area 56.

It is understood that spray instructions associated with each subset of indicators 54 and types of non-spray area 56 can be stored in memory 42 of control module 24 and recalled based on the type of non-spray area 56 indicated by indicator 54. For example, spray instructions regarding window openings of types A and B can be stored in memory 42. A first subset of indicators 54 can indicate that the non-spray area 56 is window type A and a second subset of indicators 54 can indicate that the non-spray area 56 is window type B. Control module 24 can recall spray instructions from memory 42 based on the particular indicator 54 sensed by indicator sensor 40.

In some examples, control module 24 can control spraying relative to the void 56 based on the data from indicator sensors 40 and distance sensors 38. For example, control module 24 can enter a spray adjustment mode based on AMS 12 encountering indicator 54 and determine the particular spray routine to implement based on data from distance sensors 38. In such an example, control module 24 causes AMS 12 to drive forward relative the target surface 52 upon encountering the entrance one of the indicators 54. Control module 24 receives distance data from distance sensors 38, such as the forward facing wall sensors 38a, as the AMS 12 moves forward relative the entrance one of the indicators 54. Control module 24 can determine the type of non-spray area 56 based on the distance data. For example, if the distance data indicates a sudden increase in distance, then control module 24 can classify the non-spray area 56 as a doorway, recall the spray adjustment routine associated with doorways from memory 42, and cause AMS 12 to apply fluid to the target surface 52 according to the doorway spray adjustment routine. If the distance data indicates a steady distance, then control module 24 can classify the non-spray area 56 as a window, recall the spray adjustment routine associated with windows from memory 42, and cause AMS 12 to apply fluid to the target surface 52 according to the window spray adjustment routine. The types of spray adjustment routines can be stored in memory 42 prior to operation. In some examples, AMS 12 can be configured to operate according to two types of spray adjustment routines, one based on wall sensors 38a detecting an increased distance and one based on wall sensors 38a detecting a steady distance. While the spray adjustment routine based on wall sensors 38a detecting a steady distance is discussed with regard to window openings, it is understood that the spray adjustment routine can be associated with any desired type of non-spray area 56 that does not have an increased distance at the location of wall sensors 38a, such as soffits, utility boxes, etc.

Control module 24 causes AMS 12 to apply fluid stripes according to the wall-follow routine until indicator sensor 40 senses an indicator 54. When indicator sensor 40 senses the indicator 54, control module 24 implements the spray-adjustment routine and causes AMS 12 to operate according to the spray-adjustment routine. As discussed above, control module 24 can, in some examples, implement various spray-adjustment routines depending on the information provided by indicator 54. Control module 24 can cause AMS 12 to stop spraying and traverse laterally relative to target surface 52 a set distance or until encountering another indicator 54, can cause AMS 12 to apply fluid relative the non-spray area 56, and/or can cause AMS 12 to stop operations and await further user instruction, among other options.

Spray system 10 and AMS 12 provide significant advantages. Indicators 54 are placed proximate non-spray areas 56 and indicate the presence of non-spray areas 56 to the AMS 12 during operation. Indicator sensor 40 senses the indicators 54 and can provide information to control module 24 to cause control module 24 to implement different spray routines based on the presence of that indicator 54 and, in some examples, based on data from distance sensors 38. Indicators 54 and indicator sensors 40 prevent AMS 12 from applying spray fluid to non-spray areas 56, reducing material cost and providing a more efficient spray process. AMS 12 can thereby autonomously navigate and spray relative to non-spray areas 56, increasing productivity by allowing the user to focus on other aspects of a project while AMS 12 operates. In addition, indicators 54 can be placed at any desired location in a spray site, allowing the user to define non-spray areas 56 as desired and based on the requirements of a particular job.

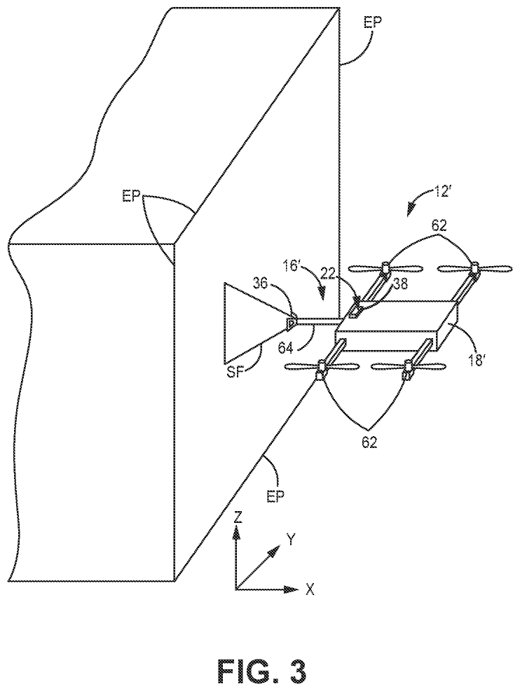

FIG. 3 is an isometric view of automated mobile sprayer (AMS) 12′. In the example shown, AMS 12′ is an unmanned aerial vehicle (UAV) configured to apply a fluid, such as paint, varnish, water, oil, stains, finishes, coatings, and solvents, among others, onto a surface. Examples surfaces can be interior, such as walls, or exterior, such as buildings, bridges, utility towers, and vehicles, among others. AMS 12′ includes spray module 16′, base 18′, sensors 22, and lift rotors 62. Spray module 16 includes nozzle 36 and spray tube 64. AMS 12′ can include additional components described with reference to AMS 12 (FIGS. 1A-1C), including a control module, user interface, control valve, etc. Sensors 22 can include distance sensors, similar to wall sensors 38a (FIGS. 1C and 2A) and path sensors 38b (FIGS. 1C and 2A), and, in some examples, indicator sensors 40. A fluid supply, similar to fluid supply 14 (FIG. 1A) can be disposed onboard AMS 12′ or offboard AMS 12′ and fluidly connected to AMS 12′.

Base 18′ supports various components of AMS 12′. Lift rotors 62 extend from base 18′ and provide lift to AMS 12′ during flight. Spray tube 64 extends from base 18′ and is configured to provide fluid to nozzle 36 from AMS 12′. Nozzle 36 is attached to spray tube 64 and configured to atomize the fluid and generate a fluid spray fan SF. In the example shown, nozzle 36 is oriented to generate a vertical spray fan for applying horizontal stripes, but it is understood that nozzle 36 can be adjusted to a different orientation to generate a horizontal spray fan or replaced with a nozzle 36 oriented to generate a horizontal spray fan for applying vertical stripes or to generate any other desired spray configuration.

Sensors 22 are disposed on base 18′ and are substantially similar to sensors 22 discussed with regard to FIGS. 1A-2B. Distance sensor 38 is shown. It is understood that AMS 12′ can include as many distance sensors 38 as desired. Distance sensor 38 can generate distance data regarding the distance to a feature of surface 52. Distance sensors 38 can be oriented to look in any direction relative to AMS 12′ to generate distance data regarding features in the travel path of AMS 12′, including above and below AMS 12′. Distance sensors 38 generate the distance data and the control module of AMS 12′, such as control module 24 (FIGS. 1B-1C), can replot the overlap for each stripe applied as AMS 12′ approaches the feature to compensate for the location of that feature. Similar to control module 24, the control module of AMS 12′ can determine a dynamic overlap parameter during operation and control movement and spraying by AMS 12′ based on the determined overlap parameter.

Similar to AMS 12, AMS 12′ can apply fluid to surface 52 according to a wall-follow routine and can operate according to an overlap adjustment routine. Unlike AMS 12, AMS 12′ is an aerial vehicle that can travel in any direction within the Z-Y plane to apply fluid, including vertically up and down, horizontally left and right, and/or a combination thereof. AMS 12′ travels horizontally relative to surface 52 to apply horizontal stripes and travels vertically relative to surface 52 to apply vertical stripes. The control module can adjust the initial overlap parameter during operation to adjust the overlap between adjacent stripes. The control module can adjust the overlap parameter based on the spacing between the current fluid stripe and the feature of surface 52. Control module 24 adjusts the overlap parameter based on the travel distance remaining to the end point of surface 52. The control module can determine the travel distance based on the distance data provided by distance sensors 38.

The control module adjusts the initial overlap parameter such that the last orthogonal fluid stripe, either vertical or horizontal, is applied on surface 52 by AMS 12′ as a full width stripe. The dynamic overlap adjustment ensures that the final stripe does not leave an unsprayed gap between the final stripe and the feature of surface 52 while maintaining sufficient overlap between adjacent stripes to provide the desired coverage. AMS 12′ continues to follow along surface 52 while applying fluid during the overlap adjustment mode.

During the overlap adjustment routine, the control module determines the dynamic overlap parameter prior to shifting AMS 12′ to apply the next stripe. The control module receives look-ahead data from distance sensors 38 and determines the distance to the feature of surface 52 based on the look-ahead data. The control module determines the number of stripes that need to be applied to reach the feature of surface 52. The overlap parameter is adjusted during the overlap adjustment routine such that the final orthogonal spray relative to surface 52 is applied at the desired location relative to the feature of surface 52 to prevent any gaps or uneven spraying.

During the overlap adjustment routine, the control module determines the distance remaining to the end point EP associated with the feature and determines a new overlap parameter based on the distance remaining and other operating parameters, such as the width of the spray fan, the type of spray tip, the desired coverage, etc. The initial overlap parameter is adjusted based on the variables and the control module controls movement and spraying by AMS 12′ based on the dynamic overlap parameter as determined by the control module.

The control module determines the dynamic overlap parameter based on a comparison between a spray parameter and a threshold parameter, such as a distance or pass count, as discussed in more detail above with reference to FIGS. 1A-1D. The control module can cause AMS 12′ to continue to operate according to a wall-follow routine if the spray parameter is greater than the threshold parameter. The control module can initiate the overlap adjustment routine based on the spray parameter equaling or being less than the threshold parameter.

For example, the control module receives look-ahead data from at least one distance sensor 38. The control module determines the spray parameter, such as the distance to the feature, based on the look-ahead data. The control module compares the spray parameter to the threshold parameter. If the spray parameter is less than the threshold distance, then the control module initiates the overlap adjustment routine.

During the overlap adjustment routine, the control module determines one or more dynamic overlap parameters and controls movement and spraying by AMS 12′ based on the dynamic overlap parameters. The control module determines an initial remaining pass count of the number of stripes that are required to fully cover surface 52 to reach the end point EP of surface 52. The initial remaining pass count can be calculated by dividing a distance to the end point EP by the overlap parameter as applied to the width of each stripe.

The control module determines a status of the remaining pass count, such as whether the remaining pass count is a whole number or a fractional number. If the remaining pass count is a fractional number, then the control module adjusts the remaining pass count to an adjusted remaining pass count that is an integer. The remaining pass count being an integer instead of a fractional number provides a full width final orthogonal stripe W (FIG. 1D) at the feature of surface 52. The fractional pass count can be adjusted up or down to the nearest adjacent integer. Adjusting to the larger next integer ensures that each portion of surface 52 receives at least two applications of the fluid. Adjusting to the closest adjacent integer minimizes any difference between the dynamic overlap parameter and the initial overlap parameter. If the remaining pass count is an integer, then the control module can utilize the initial overlap parameter to shift AMS 12′ to apply the next fluid stripe.

The control module determines the dynamic overlap parameter based on the adjusted pass count and the distance remaining to the feature. The distance remaining to the feature of surface 52 can be divided by the adjusted pass count to determine a first dynamic overlap parameter. The control module can cause AMS 12′ to shift orthogonal to the stripe axis and relative to surface 52 according to the dynamic overlap parameter. AMS 12′ is considered to be applying a fluid stripe along a first axis and AMS 12′ shifts along a second axis, which is transverse to and, in some examples, orthogonal to the first axis, to apply the adjacent fluid stripe.

After shifting and applying the adjacent stripe the control module can repeat the overlap adjustment routine to determine a second and subsequent dynamic overlap parameters. The control module determines a distance to the feature based on the look-ahead data, determines a second dynamic overlap parameter, and controls movement of the AMS 12′ based on the second dynamic overlap parameter. The control module can continue to determine additional overlap parameters throughout operation and controls operation of AMS 12′ based on those overlap parameters. The control module can continue to cause AMS 12′ to operate in the overlap adjustment mode until reaching the end point.

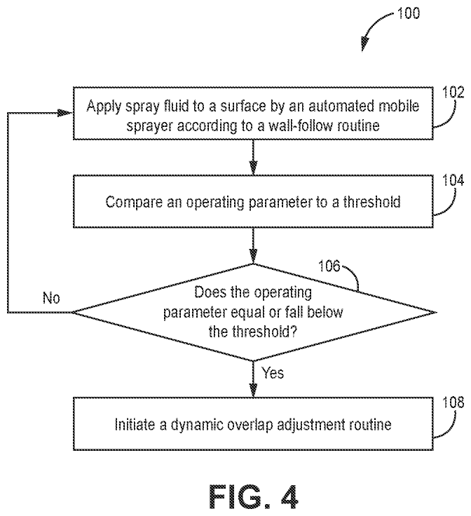

FIG. 4 is a flow chart illustrating method 100. Method 100 is a method of spraying fluid with an automated mobile sprayer, such as AMS 12 (FIGS. 1A-1C, and FIG. 2A) or AMS 12′ (FIG. 3). In step 102, the control module of the AMS, such as control module 24 (FIGS. 1B, 1C, and 2A), implements a wall-follow routine to cause AMS to apply fluid to a target surface, such as surface 52, according to the wall-follow routine. During the wall-follow routine, the AMS is spaced a first distance from the target surface. Sensor data from distance sensors oriented towards the surface, such as from wall sensors 38a (FIGS. 1C and 2A), is provided to the control module and the control module controls movement of AMS such that AMS maintains a desired orientation relative to and spacing from the surface. For example, the AMS can be maintained parallel to the target wall and spaced the first distance from the target wall. AMS applies a first fluid stripe to the target wall. The control module causes the AMS to shift relative to wall according to an initial overlap parameter. For example, the control module can activate wheel motors 32 (FIGS. 1C and 2A) of wheels 26 (FIGS. 1A-1C and 2A) to cause the AMS to shift laterally relative to the surface. The control module can determine the distance traveled based on feedback from the wheel motors, data from sensors configured to sense rotation of the wheels, look-ahead data from path sensors, such as path sensors 38b (FIG. 1C), or in any other desired manner. The AMS continues to apply fluid according to the wall-follow routine until an operational parameter reaches a threshold.

In step 104, the control module compares an operational parameter to a threshold. The threshold is based on the spacing of AMS from the end point of the target wall. The end point is the location where AMS ends the wall-follow routine relative to the feature of the wall. For example, the end point can be located at the feature or spaced from the feature. The operational parameter can be determined based on look-ahead data provided by the path sensors of the AMS. For example, the operational parameter can be a distance remaining to the end point and/or a number of spray passes remaining to the end point, among other options. The threshold can be a threshold distance and/or a threshold pass count, among other options.

In step 106 the control module compares the operational parameter to the threshold to determine if the operational parameter is equal to or less than the threshold. If the answer to step 106 is NO, then method proceeds back to step 102 and the AMS continues to operate according to the wall-follow routine and in the wall-follow mode. If the answer to step 106 is YES, then method proceeds to step 108 and the control module initiates an overlap adjustment routine and causes the AMS to operate in the overlap adjustment mode.

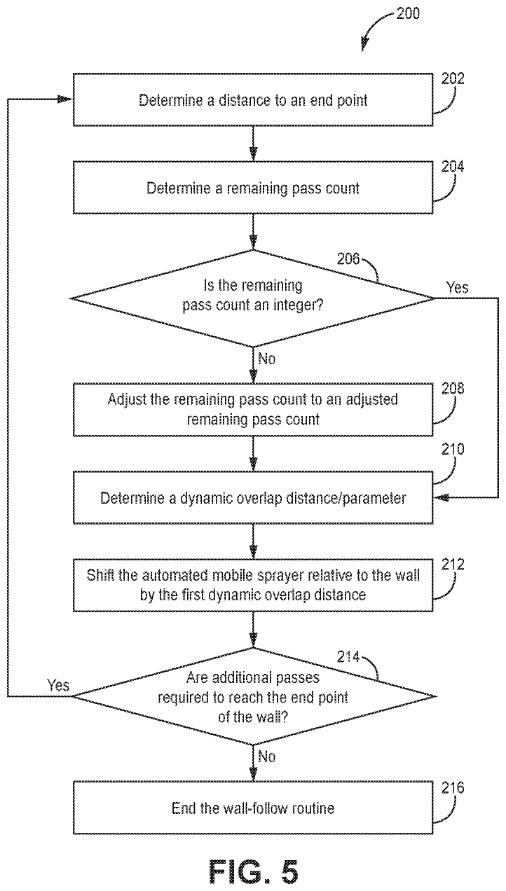

FIG. 5 is a flowchart illustrating method 200. Method 200 is a method of applying fluid from an automated mobile sprayer, such as AMS 12 (FIGS. 1A-1C, 2A) and AMS 12′ (FIG. 3), according to an overlap adjustment routine. The dynamic overlap routine positions the AMS such that the final spray relative to the target wall is applied at the end point of the target wall, preventing the formation of gaps and preventing uneven spraying. The overlap adjustment routine further provides even fluid application as AMS approaches the end of the wall-follow routine.

In step 202, the control module of AMS, such as control module 24 (FIGS. 1B, 1C, and 2A), determines a distance to a feature and/or end point associated with that feature on the target wall, such as end point EP (FIGS. 1C, 1D, and 2A) of surface 52 (FIGS. 1A-2B). The end point is the location where AMS stops the wall-follow routine and ends spraying or transitions to another routine. For example, the end point can be located at the feature or spaced from the feature. The distance to the end point is determined based on distance data from distance sensors, such as look-ahead data provided by path sensors of the AMS, such as path sensors 38b (FIGS. 1C and 2A).

In step 204, the control module determines a remaining pass count of the number of stripes that need to be applied to the target surface to reach the end point of the target surface. The control module determines the remaining pass count prior to shifting AMS to apply the next fluid stripe. The remaining pass count is determined based on the distance to the end point and the width of the additional coverage provided by each application pass of the AMS. For example, the remaining pass count can be determined by dividing the distance to the end point by the width of the additional fluid applied with each spray pass.

In step 206, the control module determines a status of the remaining pass count, such as whether the remaining pass count is a fractional number or an integer. If the remaining pass count is an integer, then the answer is YES and method 200 proceeds to step 210 where the remaining pass count functions as the adjusted remaining pass count. If the remaining pass count is a fractional number, then the answer is NO and method 200 proceeds to step 208.

In step 208, the fractional remaining pass count is adjusted to an adjusted remaining pass count that is an integer. The pass count value of the fractional remaining pass count can be adjusted up or down to the nearest adjacent integer. In some examples, the fractional remaining pass count is adjusted to the nearest integer larger than the fractional remaining pass count. Adjusting to the larger next integer ensures that each portion of the target surface receives at least two applications of the fluid. In some examples, the fractional remaining pass count is adjusted to the closest adjacent integer. Adjusting to the closest adjacent integer minimizes any difference between the dynamic overlap parameter and the initial overlap parameter.

In step 210, a dynamic overlap parameter is determined based on the adjusted remaining pass count and the coverage width of each stripe. The distance to the end point is divided by the adjusted remaining pass count to provide the dynamic overlap parameter. The resulting distance is a dynamic overlap distance. A dynamic overlap percentage can be calculated based on the dynamic overlap distance and the width of the spray fan at the target surface. In some cases, the control module can compare the dynamic overlap percentage to a percent threshold to determine if the dynamic overlap percentage falls within a desired range as defined by the percent threshold. The dynamic overlap percentage can be adjusted to fall within the threshold range.

In step 212, the control module causes the AMS to shift relative to the target surface according to the dynamic overlap parameter. The control module causes the AMS to shift relative to the target surface by the dynamic overlap distance and apply a fluid stripe at the new position.

In step 214, the control module determines whether additional fluid stripes need to be applied to the target surface to reach the end point of the target surface. For example, the control module can determine whether additional stripes are required based on the look-ahead data from the path sensors. If additional passes are required, then method 200 proceeds back to step 202 and continues applying fluid stripes according to the overlap adjustment routine. If AMS has reached the end point of wall, then additional passes are not required and method 200 proceeds to step 216. In step 216, the control module ends the wall-follow routine and can stop spraying or initiate another spray routine.

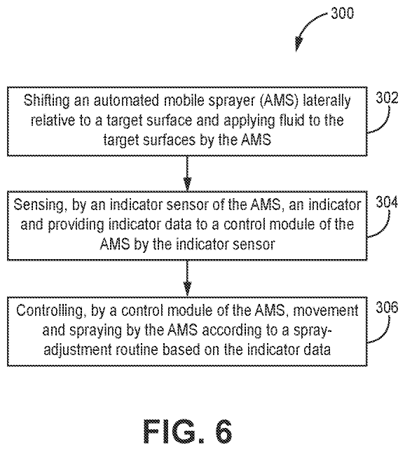

FIG. 6 is a flowchart illustrating method 300. Method 300 is a method of operating an automated mobile sprayer (AMS), such as AMS 12 (FIGS. 1A-1C, 2A), to apply fluid to a target surface based on data from indicators, such as indicators 54 (FIGS. 1A, 2A, and 2B). In step 302, the AMS is shifted laterally relative the target surface and applies spray fluid to the target surface. For example, a control module of the AMS, such as control module 24 (FIGS. 1C and 2A), can cause the AMS to shift laterally and can control spraying by the AMS. In some examples, the control module causes the AMS to operate according to a wall-follow routine in step 302.

In step 304, an indicator sensor, such as indicator sensor 40 (FIGS. 1B, 1C, and 2A), senses an indicator, such as indicator 54 (FIGS. 1A, 2A, and 2B), encountered by AMS 12. The indicator sensor generates indicator data, which can be a signal generated by indicator sensor indicating that an indicator is encountered, and provides that indicator data to the control module. The indicator sensor sensing the indicator indicates the presence of a non-spray area, which is an area of the target surface on which the spray fluid is not meant to be applied.

In step 306, the control module controls movement and spraying by the AMS relative to the target surface based on the indicator data. For example, the control module can exit the wall-follow routine and control movement and spraying by AMS according to a spray-adjustment routine. One or more spray-adjustment routines can be stored in a memory of control module, such as memory 42 (FIGS. 1C and 2A), and recalled based on the indicator data. In some examples, the control module can cause the AMS to drive forward relative to the target surface and determine the spray adjustment routine based on distance data generated by distance sensors, such as wall sensors 38a (FIGS. 1C and 2A). The spray-adjustment routine provides instructions to control module 24 for controlling movement of the AMS and spraying by the AMS relative to the non-spray area. In some examples, the control module can exit the spray-adjustment routine based on the indicator sensor sensing a second indicator that indicates the end of the non-spray area. In some examples, the control module can resume spraying according to step 302, such as via a wall-follow routine, after exiting the spray-adjustment routine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1-31. (canceled)

32. An automated mobile sprayer (AMS) configured to spray fluids onto a target surface, the AMS comprising:
a mobile base having a lateral axis and a longitudinal axis;
a drive system that moves the mobile base;
a spray module supported by the mobile base, the spray module movable along a vertical axis relative to the base, the spray module including a nozzle configured to spray the fluid longitudinally towards the target surface;
one or more indicator sensors configured to sense a first indicator encountered by the AMS and generate first indicator data based on the sensed first indicator mat; and
control circuitry configured to:
drive the AMS via the drive system along the target surface,
control spraying by the AMS based on the first indicator data.

33. The AMS of claim 32, wherein the control circuitry is configured to:
determine that a non-spray area is present on the target surface based on the first indicator data.

34. (canceled)

35. The AMS of claim 32, wherein the one or more indicator sensors are configured to sense the first indicator based on the AMS passing directly over the first indicator.

36. The AMS of claim 32, wherein the indicator sensor is one of an optical sensor and a proximity sensor.

37. The AMS of claim 36, wherein the proximity sensor includes one of an RFID tag, an RFID receiver, an inductive sensor, and a capacitive sensor.

38. (canceled)

39. The AMS of claim 32, wherein the indicator sensor is disposed in the mobile base.

40. The AMS of claim 32, wherein the first indicator is an indicator mat.

41. The AMS of claim 40, wherein the control module is further configured to:
stop spraying by the AMS based on the first indicator data.

42. The AMS of claim 41, wherein the control module is further configured to:
cause the AMS to traverse laterally relative to the target surface without spraying based on the first indicator data.

43. The AMS of claim 42, wherein the control module is further configured to:
resume spraying by the AMS based on the control module receiving second indicator data generated by the indicator sensor sensing a second indicator mat.

44. The AMS of claim 32, wherein the control module is further configured to:
control spraying by the AMS such that the AMS applies partial swaths of spray fluid to the target surface based on the first indicator data.

45. A spray system comprising:
at least one indicator; and
an automated mobile sprayer (AMS) configured to spray fluids onto a target surface, the AMS comprising:
a mobile base having a lateral axis and a longitudinal axis;
a drive system that moves the mobile base;
a spray module supported by the mobile base, the spray module movable along a vertical axis relative to the base, the spray module including a nozzle configured to spray the fluid longitudinally towards the target surface;
an indicator sensor configured to sense the at least one indicator and generate indicator data regarding the at least one indicator; and
control circuitry configured to:
drive the AMS via the drive system along the target surface,
detect a non-spray area of the target surface based on the indicator data, and
control spraying by the AMS, based on the indicator data, such that the AMS does not apply fluid spray to the non-spray area.

46. The spray system of claim 45, wherein the at least one indicator is configured to be placed one of on a ground surface proximate the target surface and on a vertical surface.

47. The spray system of claim 45, wherein the at least one indicator includes a sensor component connected to a support component.

48. The spray system of claim 47, wherein the sensor component is one of an RFID tag and an RFID reader.

49. The spray system of claim 47, wherein the sensor component is an inductive sensor component.

50. The spray system of claim 45, wherein the at least one indicator includes a metallic component and the indictor sensor is configured to generate the indicator data based on sensing the metallic component.

51. A method comprising:
shifting an automated mobile sprayer (AMS) laterally relative to a target surface in a first lateral direction;
spraying fluid onto the target surface from a spray module of the AMS as the spray module moves relative to the target surface;
sensing, by an indicator sensor of the AMS, an indictor disposed proximate a non-spray area of the target surface; and
stopping, by a control module of the AMS, spraying based on the indicator sensor sensing the indicator.

52. (canceled)

53. The method of claim 51, wherein sensing, by the indicator sensor of the AMS, the indicator, includes:
sensing, by a first proximity sensing component, a second proximity sensing component associated with the indicator.

54. (canceled)

55. The AMS of claim 32, wherein the control circuitry is configured to:
receive the look-ahead data from at least one path sensor oriented to look ahead on a travel path of the AMS and to generate look-ahead data regarding a distance to a feature in the travel path;
determine a first distance to the feature;
determine a first overlap parameter of vertical swaths of the spray fluid applied by the spray module based on the first distance, the first overlap parameter indicting a first degree of overlap between consecutive vertical swaths sprayed by the spray module;
control the mobile base and the spray module to spray at least one vertical swath based on the first overlap parameter for a first portion of the target surface;
determine a second distance to the feature, the second distance shorter than the first distance;
determine a second overlap parameter of the vertical swaths based on the second distance, the second overlap parameter indicting a second degree of overlap between consecutive vertical swaths sprayed by the spray module; and
control the mobile base and the spray module to spray at least one vertical swath based on the second overlap parameter for a second portion of the target surface.
